(19) United States
(12) Patent Application Publication
(10) Pub. No.: US 2009/0083770 A1
(43) Pub. Date: Mar. 26, 2009

(54) RECORDING MEDIUM PLAYBACK DEVICE

(75) Inventor: Shinichi Tarumoto, Saitama (JP)

Correspondence Address: SUGHRUE MION, PLLC, 2100 PENNSYLVANIA AVENUE, N.W., SUITE 800, WASHINGTON, DC, 20037, US

(73) Assignee: PIONEER CORPORATION, Meguro-ku, Tokyo (JP)

(21) Appl. No.: 11/908,158

(22) PCT Filed: Mar. 6, 2006
(86) PCT No.: PCT/JP2006/304270

§ 371 Date: Sep. 10, 2007

(30) Foreign Application Priority Data
Mar. 9, 2005 (JP) 2005-065029

(51) Int. Cl. G11B 17/04

(52) U.S. Cl. 720/601

(57) ABSTRACT

A recording medium playback device, which enables to decrease time and labor required for a passenger to exchange the recording media, is provided. A CD player 1 includes a device body 3, conveying unit 5, playback unit 5, and holding member 7. The device body 3 is provided with an insertion opening 10. The conveying unit 5 takes a CD 2 into and out from the device body 3. The playback unit 6 reads out information recorded in the CD 2. The holding member 7 holds the CD 2 ejected outside the device body 3 in cooperation with an inner edge of the insertion opening 10. The holding member 7permits a new CD 2a to be inserted into the device body 3 on a condition that the holding member 7 holds the CD 2.

### TECHNICAL FIELD

The present invention relates to a recording medium playback device which is mounted on a motor vehicle and so on and plays back information recorded in a recording medium.

### BACKGROUND ART

For example, a compact disk player (CD player) as a recording medium playback device, which reads out information recorded in an optical disk as a recording medium such as a compact disk (CD) and plays back the read-out information, includes: a device body having an insertion opening through which a recording medium can be taken in and out; a playback unit which is provided in the device body and can read out information recorded in the recording medium; and a conveying unit which conveys the recording medium between the insertion opening and the playback unit so as to take the recording medium into and out from the device body.

As for the recording medium playback device described above, when the recording medium is to be exchanged, first, the recording medium ejected from the device body by the conveying unit is taken out and then, a new recording medium is inserted into the device body. Therefore, when being mounted on a motor vehicle, the recording medium playback device described above requires a passenger to take out the recording medium ejected from the device body and thereafter to insert a new recording medium into the device body. That is, it is necessary for a passenger to exchange the recording media.

### DISCLOSURE OF THE INVENTION

### Problems that the Invention is to Solve

As mentioned above, when the recording media to be played back are exchanged, the conventional recording medium playback device requires a passenger to take out the recording medium ejected from the device body and thereafter to insert a new recording medium into the device body. That is, a passenger needs to exchange the recording media. Therefore, it has been demanded to decrease time and labor required for a passenger to exchange the recording media.

It is therefore an objective of the present invention to provide a recording medium playback device which enables to decrease time and labor required for a passenger to exchange the recording media.

### Means of Solving the Problems

In order to solve the above problem and attain the above objective, the present invention defined in claim 1 is a recording medium playback device including: a device body having an insertion opening through which a recording medium passes; a conveying unit which takes the recording medium into and out from the device body; a playback unit which reads out information recorded in the recording medium inserted in the device body; and a holding member provided between the insertion opening and the conveying unit, wherein the holding member, together with an inner edge of the insertion opening, abuts against the recording medium taken out from the device body by the conveying unit and permits another recording medium to be conveyed to the playback unit by the conveying unit on a condition that the holding member holds the recording medium in cooperation with the inner edge of the insertion opening.

### BRIEF DESCRIPTION OF THE DRAWINGS

FIG. 1 A perspective view of a CD player as a recording medium playback device according to a preferred embodiment of the present invention

FIG. 2 A perspective view illustrating a state when an operation unit shown in FIG. 1 is positioned at an insertion-ejection position

FIG. 3 A view partly showing with a cross section taken along III-III line in FIG. 2

FIG. 4 A view partly showing with a cross section taken along IV-IV line in FIG. 2

FIG. 5 A view illustrating, partly with a cross section, a state when a CD inserted in the CD player shown in FIG. 3 abuts against a holding member

FIG. 6 A view illustrating, partly with a cross section, a state when the CD shown in FIG. 5 is nipped between a disk guide and a roller of a conveying unit

FIG. 7 A view illustrating, partly with a cross section, a state when the CD shown in FIG. 6 is being conveyed into a device body by the conveying unit

FIG. 8 A view illustrating, partly with a cross section, a state when the CD shown in FIG. 7 is clamped by a clamping part of a playback unit

FIG. 9 A view illustrating, partly with a cross section, a state when the CD shown in FIG. 8 is nipped between the disk guide and the roller of the conveying unit

FIG. 10 A view illustrating, partly with a cross section, a state when the CD shown in FIG. 9 abuts against a second guide surface of the holding member

FIG. 11 A view illustrating, partly with a cross section, a state when the CD shown in FIG. 10 is being ejected to the outside of the device body by the conveying unit

FIG. 12 A view illustrating, partly with a cross section, a state when the CD shown in FIG. 11 is held by the holding member and so on

FIG. 13 A view illustrating, partly with a cross section, a state when a new CD is inserted in the CD player on a condition that the CD shown in FIG. 12 is held by the holding member and so on

FIG. 14 A view illustrating, partly with a cross section, a state when the new CD shown in FIG. 13 is nipped between the disk guide and the roller of the conveying unit

FIG. 15 A view illustrating, partly with a cross section, a state when the new CD shown in FIG. 14 is being conveyed into the device body by the conveying unit

FIG. 16 A view illustrating, partly with a cross section, a state when the new CD shown in FIG. 15 is clamped by the clamping part of the playback unit

### ABBREVIATION NUMERALS

1: CD player (recording medium playback device)

2, 2a: CD (recording medium)

3: device body

5: conveying unit

6: playback unit

7: holding member

10: insertion opening

25: first guide surface

26: second guide surface

### BEST MODE FOR CARRYING OUT THE INVENTION

In the following, a recording medium playback device according to a preferred embodiment of the present invention will be explained. In the recording medium playback device according to a preferred embodiment of the present invention, a holding member holds a recording medium ejected from a device body in cooperation with an inner edge of an insertion opening and permits a new recording medium to be inserted into the device body. That is, the recording medium playback device enables that a new recording medium is permitted to be inserted into the device body on a condition that the recording medium being ejected from the device body is temporarily held. As a result, the recording medium playback device decreases a frequency of exchanging the recording media, so that time and labor required for a passenger to exchange the recording media can be reduced.

Further, the holding member may include: a first guide surface which guides the recording medium being inserted into the device body to one side of the holding member; and a second guide surface which guides the recording medium being ejected from the device body to another side of the holding member. In this case, since a conveying route can be divided into a conveying path of the recording medium being inserted into the device body and a conveying path of the recording medium being ejected from the device body, a new recording medium can be securely inserted into the device body on a condition that the ejected recording medium is temporarily held at the device body.

Furthermore, the first guide surface is gradually inclined toward said one side of the holding member as the first guide surface approaches the depth of the device body, and the second guide surface is gradually inclined toward said another side of the holding member as the second guide surface approaches the outside of the device body. In such a case, since the first guide surface is gradually inclined upward as the first guide surface approaches the depth of the device body, therefore the recording medium being inserted into the device body can be securely positioned at an upper side of the holding member, and since the second guide surface is gradually inclined downward as the second guide surface approaches the outside of the device body, therefore the recording medium being ejected from the device body can be securely positioned at a lower side of the holding member.

### EXAMPLES

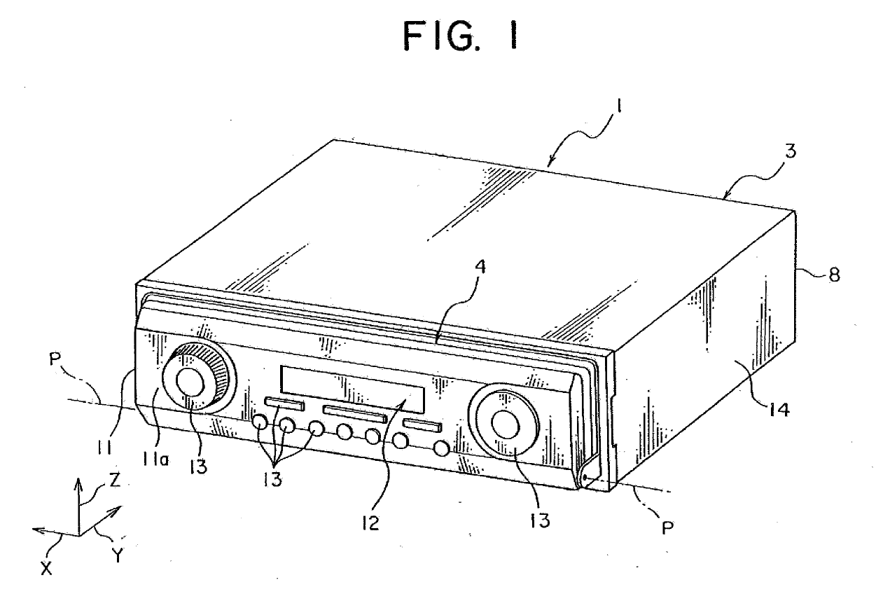

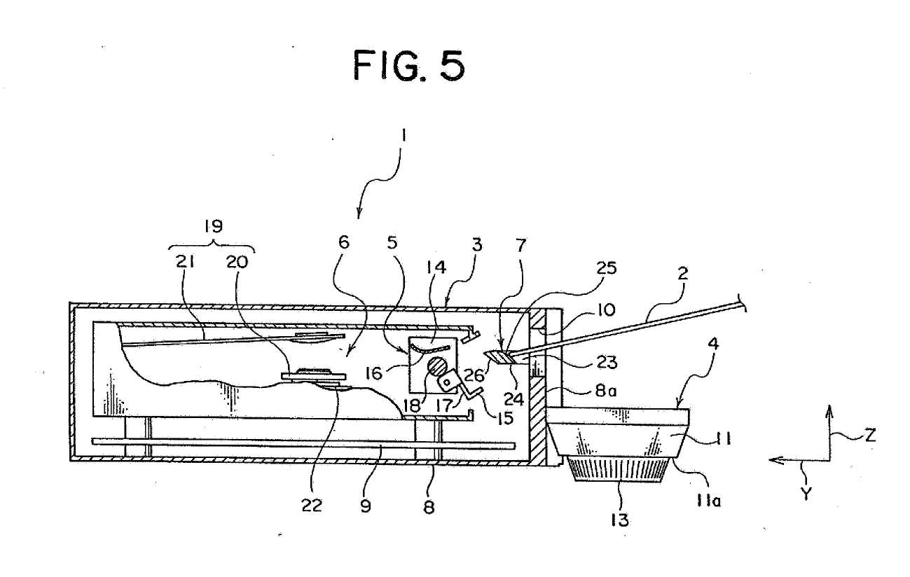

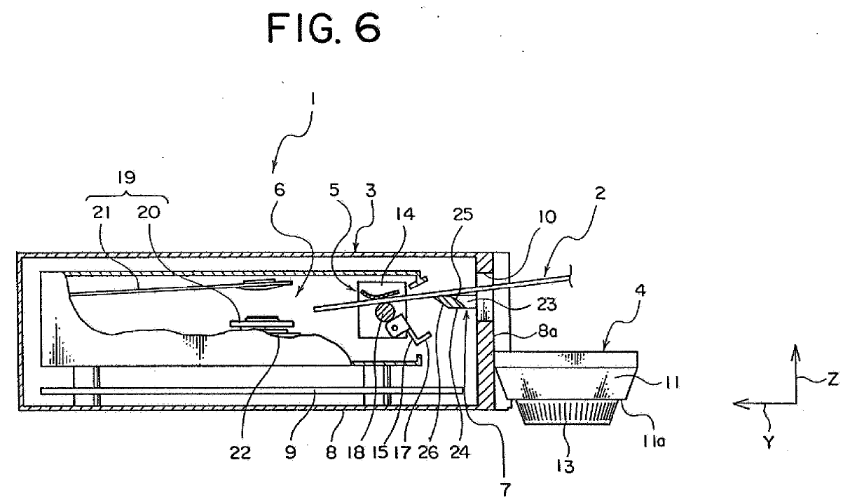

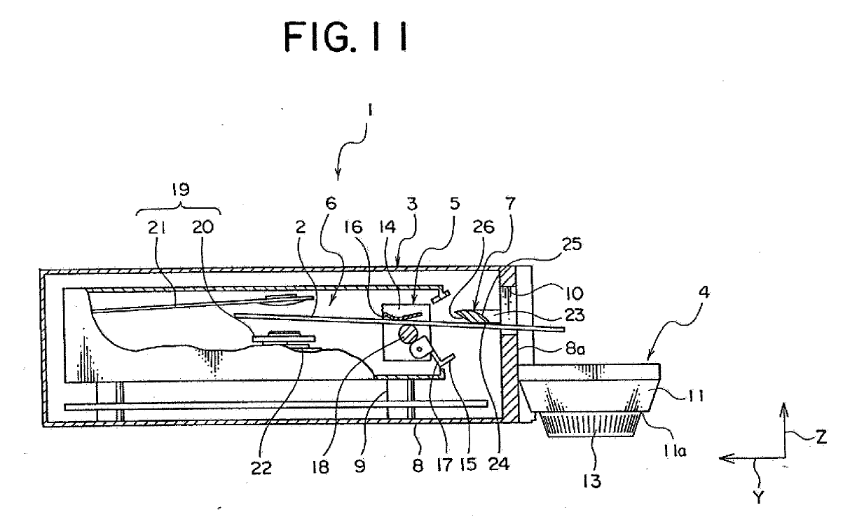

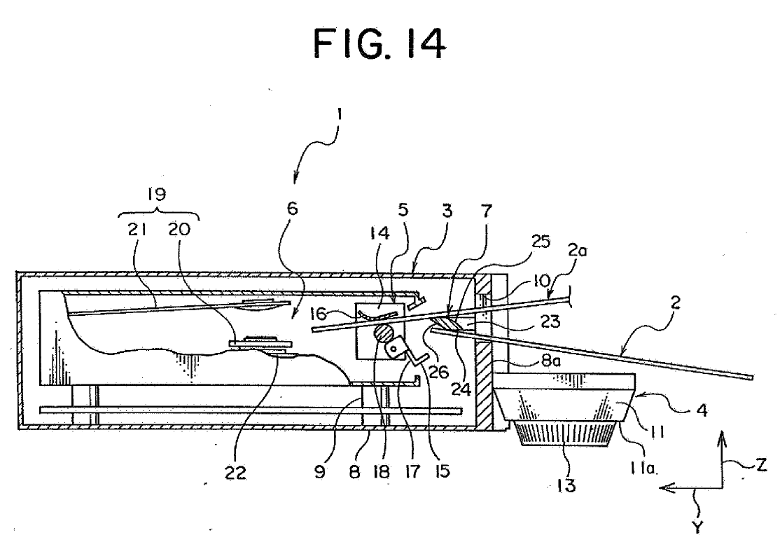

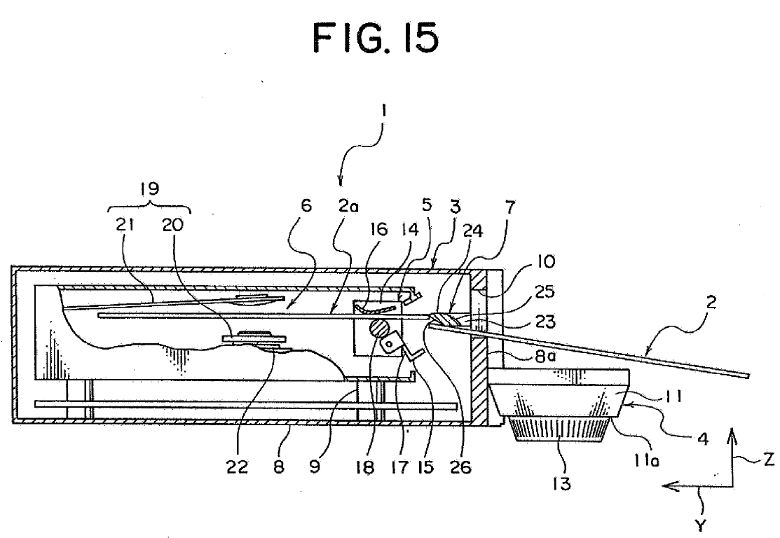

In the following, a CD player 1 as an example of a recording medium playback device according to a preferred embodiment of the present invention will be explained with reference to FIGS. 1-16. The CD player shown in FIG. 1 is attached to an instrument panel or the like in a motor vehicle as a mobile unit, receives a CD 2 (shown in FIGS. 5 and 6) as a recording medium therein, reads out (i.e. plays back) information recorded in the CD 2, and outputs the read-out information as a sound or voice. The CD 2 is formed in a disk-shape, in which information readable by an electronic instrument such as a computer is recorded.

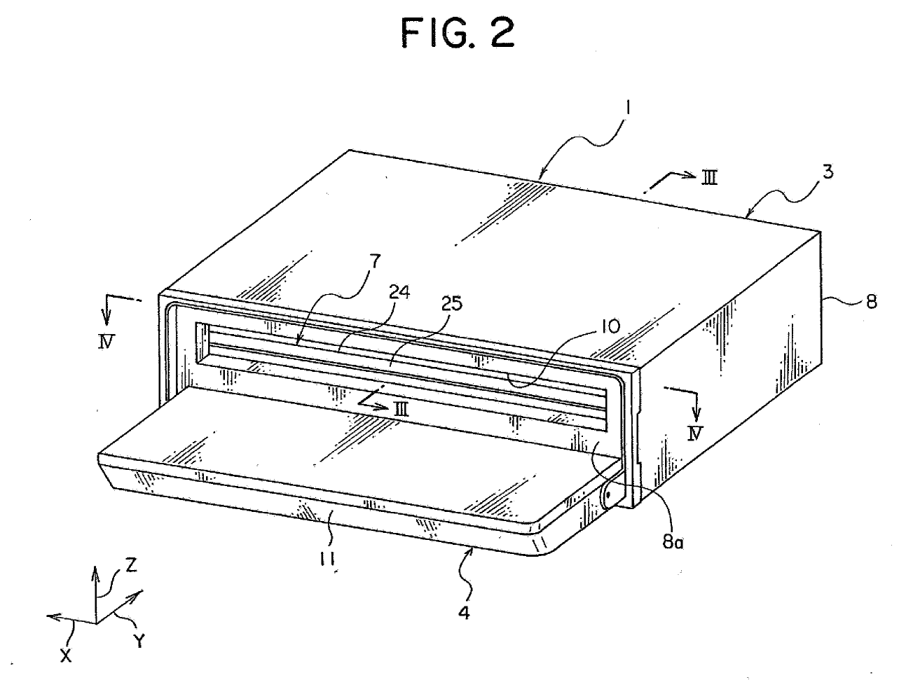

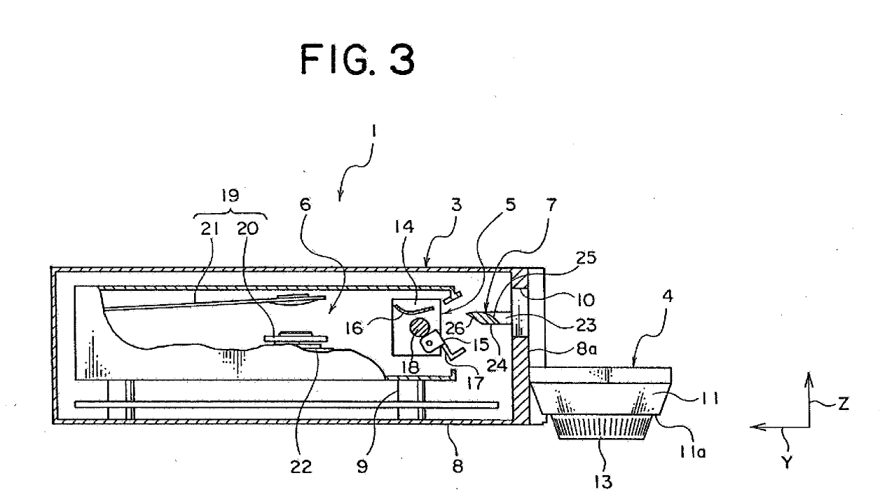

As shown in FIGS. 1 and 2, the CD player 1 includes a device body 3 (shown in FIG. 1), operation unit 4, conveying unit 5 (shown in FIG. 3), playback unit 6 (shown in FIG. 3), interlock mechanism, and holding member 7. Hereinafter, a direction indicated by an arrow X in FIG. 1 denotes a width direction of the CD player 1, a direction indicated by an arrow Y in FIG. 1 denotes a depth direction of the CD player 1, and a direction indicated by an arrow Z in FIG. 1 denotes a thickness direction of the CD player 1.

The device body 3 includes an outer case 8 (shown in FIG. 1) made of synthetic resin and a fixing chassis 9 (shown in FIG. 3) made of sheet metal or the like.

The outer case 8 is formed in a flat box-shape. When the outer case 8 is attached to the instrument panel described above, a front surface 8a (shown in FIG. 2), which faces a passenger, is provided with an insertion opening 10 through which the CD 2 can be taken in and taken out. The insertion opening 10 penetrates through an outer wall of the outer case 8. The insertion opening 10 can insert the CD 2 to the inside thereof. The CD 2 is received into the outer case 8, i.e. into the device body 3 or ejected from the device body 3 through the opening 10. That is, the insertion opening 10 permits the CD 2 to be inserted into or ejected from the device body 3.

The fixing chassis 9 is received in the outer case 8 and fixed to the outer case 8.

As shown in FIG. 1, the operation unit 4 includes a flat box-shaped housing 11, a liquid crystal display (LCD) 12 as a display panel received in the housing 11, and various switches 13. The housing 11 is formed in a flat box-shape in which the length and width of the housing 11 are approximately equal to the width and thickness of the device body 3, respectively.

The LCD 12 includes a display surface as a display section which displays various information to a user. The various switches 13 construct an operation part which is operated by a user. The display surface and the operation part are provided on a surface 11a which is located at this side of the housing 11 in FIG. 1. The surface 11a is an exposed surface 11a.

When a user operates the switches 13 of the operation unit 4, for example, a selection of a program for the CD 2 to be played back by the playback unit 6 and an insertion and ejection of the CD 2 are carried out. Then, information such as a program name under playback is displayed on the LCD 12 of the operation unit 4.

The operation unit 4 is positioned in front of the front surface 8a of the device body 3. Then, the exposed surface 11a of the operation unit 4 is exposed in front of the front surface 8a of the device body 3.

The operation unit 4 is formed rotatable around an axis P, which is parallel to the width direction X and passes a lower end part of the operation part 4. The operation unit 4 is rotated around the axis P by a drive mechanism received in the device body 3. The operation unit 4 rotates around the axis P so as to be displaced between an operation position shown in FIG. 1 where the operation unit 4 covers the insertion opening 10 and exposes the exposed surface 1 la and an insertion-ejection position shown in FIG. 2 where the operation part 4 opens the insertion opening 10 and shifts the exposed surface 11a downward.

The drive mechanism described above is provided with a sensor (explained later) capable of detecting whether or not the CD 2 is held by the holding member 7.

The conveying unit 5 is received in the device body 3 and includes a unit body 14, roller arm 15, and disk guide 16 as shown in FIG. 3. The unit body 14 is supported by a rubber, damper or the like movably along the width direction X, depth direction Y and thickness direction Z with respect to the device body 3.

The roller arm 15 is arranged in the proximity of the insertion opening 10. The roller arm 15 includes an arm body 17 made of sheet metal or the like and a roller 18.

The arm body 17 is provided at both ends in the width direction X of the device body 3. The arm body 17 is supported by the unit body 14 rotatably around one end of the arm body 17. The arm body 17 is urged in a direction, in which the roller 18 approaches the disk guide 16, by a spring or the like (not shown).

The roller 18 is rotatably supported by an opposite end of the arm body 17. The longitudinal direction of the roller 18, that is, the rotation axis of the roller 18 is parallel to the width direction X of the device body 3. The roller 18 is rotated by a motor or the like as a driving source (not shown).

The disk guide 16 is formed in a belt-shape and has the longitudinal direction parallel to the width direction X of the device body 3. The disk guide 16 is formed in a thin plate-shape.

The conveying unit 5 nips the CD 2 between the disk guide 16 and the roller 18 and conveys the CD 2 through the insertion opening 10 so as to take the CD 2 into and out from the device body 3.

The playback unit 6 is received in the device body 3 and includes a clamping part 19 and a pickup part.

As shown in FIG. 3, the clamping part 19 includes a turntable 20 and a clamp arm 21. The turntable 20 is provided rotatably on the fixing chassis 9. The turntable 20 is rotated by a spindle motor 22 or the like. The clamp arm 21 is formed in a plate-shape and is rotatable around one end of the clamp arm 21, said end being located away from the insertion opening 10.

When the clamp arm 21 rotates around the one end thereof, an opposite end thereof approaches and leaves the turntable 20. The clamping part 19 positions the CD 2, which is inserted in the device body 3 passing through the insertion opening 10, on the turntable 20. The opposite end of the clamp arm 21 approaches the turntable 20 so as to nip the CD 2 between the turntable 20 and the clamp arm 21, thereby clamping the CD 2.

The pickup part includes an optical pickup as a playback element and a pickup-transferring part. The optical pickup reads out information recorded in the CD 2 clamped by the clamping part 19. The pickup-transferring part transfers the optical pickup along in a diameter direction of the CD 2 clamped by the clamping part 19.

The pickup part transfers the optical pickup in the diameter direction of the CD 2 and reads out information from a given position of the CD 2 clamped by the clamping part 19.

In the playback unit 6, the clamping part 19 clamps the CD 2 and the pickup part reads out information from the CD 2.

The interlock mechanism interlocks an action of the clamping part 19 and that of the conveying unit 5 such that the roller 18 and the disk guide 16 in the conveying unit 5 leave each other simultaneously when the opposite end of the clamp arm 21 of the clamping part 19 approaches the turntable 20 (that is, when the CD 2 is clamped by the clamping part 19). Further, the interlock mechanism interlocks an action of the clamping part 19 and that of the conveying unit 5 such that the roller 18 and the disk guide 16 in the conveying unit 5 approach each other simultaneously when the opposite end of the clamp arm 21 of the clamping part 19 leaves the turntable 20 (that is, when clamping of the CD 2 by the clamping part 19 is removed). Thus, the interlock mechanism interlocks the clamping action of the clamping part 19 and the action of the conveying unit 5 so that one of the clamping part 19 and the conveying unit 5 holds the CD 2.

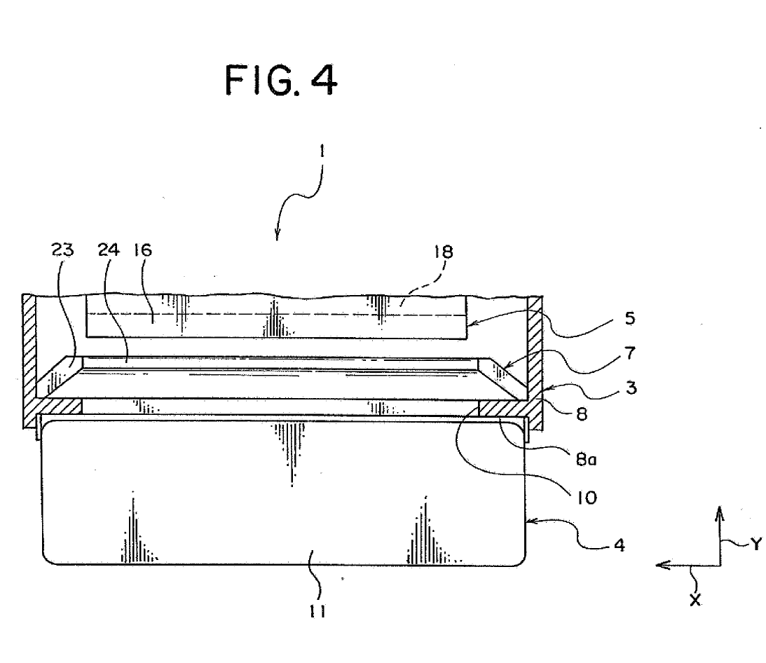

The holding member 7 is received in the device body 3. As shown in FIGS. 3 and 4, the holding member 7 includes a holding arm 23 and a holding part 24. The holding arm 23 is provided at both ends in the width direction X of the device body 3. The holding arm 23 extends from an inner surface of the device body 3 toward the conveying unit 5.

The holding part 24 is formed in a bar-shape and has a longitudinal direction parallel to the width direction X. The holding part 24 is formed over the whole length of the insertion opening 10. The holding part 24, i.e. the holding member 7 is provided between the insertion opening 10 and the conveying unit 5 (i.e. between the insertion opening 10 and the playback unit 6). A thickness of the holding part 24 in the thickness direction Z is formed considerably smaller than a thickness of the insertion opening 10 in its thickness direction. The holding part 24 is situated at the center of the insertion opening 10 as to the direction Z and at the same time situated along the direction Y within the device body 3.

Since the thickness of the holding part 24 is smaller than that of the insertion opening 10 and the holding part 24 is situated at the center of the insertion opening 10 in the direction Z and at the same time situated along the direction Y within the device body 3, therefore when the CD 2 positioned at the lower side of the holding part 24 comes in contact with an lower edge of the inner edge of the insertion opening 10, the holding member 7, together with the lower edge of the inner edge of the insertion opening 10, abuts against the CD 2 and holds the CD 2 in cooperation with the lower edge of the inner edge of the insertion opening 10. Thus, the holding member 7 holds the CD 2, which is ejected from the device body 3 by the conveying unit 5.

Since the holding member 7 holds the CD 2 at the lower side of the holding part 24 (i.e. the another side of the holding member), therefore a new CD 2, which is inserted in the device body 3 through the insertion opening 10, is permitted to pass the upper side of the holding part 24 (i.e. the one side of the holding member) so as to be conveyed to the playback unit 6.

The holding part 24 is provided with a first guide surface 25 and a second guide surface 26 in its section. The first guide surface 25 is formed on an edge part of the holding part 24 near to the insertion opening 10 over the whole length of the edge part, i.e. over the whole length in the width direction X. The first guide surface 25 is gradually inclined upward (i.e. toward the one side of the holding member 7) as the first guide surface 25 approaches the playback unit 6 from the insertion opening 10.

The first guide surface 25 is provided at a position where the first guide surface 25 is capable of abutting against the CD 2 being inserted into the device body 3 through the insertion opening 10 from one side of the holding member 7 (i.e. from the upper side of the holding member 7). Further, the first guide surface 25 is provided at a position where the first guide surface 25 is capable of guiding the CD 2 inserted in the device body 3 to between the disk guide 16 and the roller 18 of the conveying unit 5. The first guide surface 25 abuts against the CD 2 being inserted into the device body 3 and guides the CD 2 to the upper side of the holding part 24, i.e. to the upper side of the holding member 7.

The second guide surface 26 is formed on an edge part of the holding part 24 away from the insertion opening 10 over the whole length of the edge part, i.e. over the whole length in the width direction X. The second guide surface 26 is gradually inclined downward (i.e. toward the other side of the holding member 7) as the second guide surface 26 approaches the insertion opening 10 from the playback unit 6.

The second guide surface 26 is provided at such a position that the unit body 14 of the conveying unit 5 is positioned at a normal position and the second guide surface 26 is disposed along the depth direction Y with the CD 2 nipped between the disk guide 16 and the roller 18. That is, the second guide surface 26 is provided at a position where the second guide surface 26 is capable of abutting against the CD 2 being ejected from the device body 3 to the outside by the conveying unit 5. The second guide surface 26 abuts against the CD 2 being ejected from the device body 3 to the outside and guides the CD 2 to the lower side of the holding part 24, i.e. to the lower side of the holding member 7.

The CD player 1 constructed as described above receives the CD 2 in the device body 3, reads out information recorded in the CD 2, and allows the holding member 7 to hold the CD 2 ejected from the device body 3. First, in the CD player 1, before receiving the CD 2 in the device body 3, as shown in FIG. 1, the operation unit 4 is positioned at an operation position and as shown in FIG. 3, the disk guide 16 and the roller 18 of the conveying unit 5 are situated closely to each other, and the clamp arm 21 and the turntable 20 are situated away from each other.

Then, when the switch 13 for inserting the CD 2 into the device body 3 is operated, first, as shown in FIGS. 2-4, the drive mechanism acts to rotate the operation unit 4 so as to position the operation unit 4 at an insertion-ejection position. Thus, the insertion opening 10 provided on the device body 3 is opened.

Then, the CD 2 is inserted into the insertion opening 10. Then, as shown in FIG. 5, the CD 2 abuts against the first guide surface 25. Then, the CD 2 inserted in the device body 3 by the first guide surface 25 is guided to the upper side of the holding part 24 of the holding member 7 and nipped between the disk guide 16 and the roller 18 of the conveying unit 5 as shown in FIG. 6.

Then, the roller 18 rotates in a direction in which the CD 2 is received into the device body 3, so that the conveying unit 5 gradually receives the CD 2 into the device body 3. At that time, the unit body 14 of the conveying unit 5 appropriately shifts in the directions X, Y and Z in response to the movement of the CD 2.

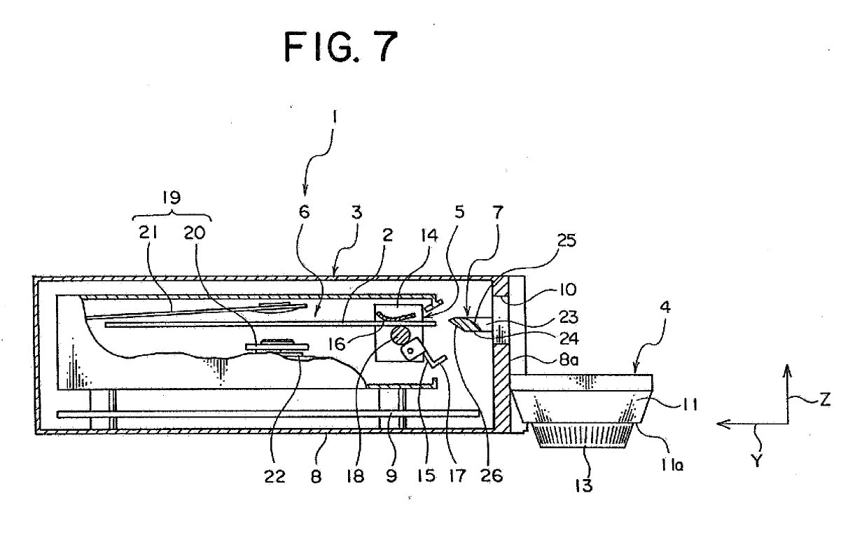

Then, the CD 2 inserted in the device body 3 is positioned between the turntable 20 and the clamp arm 21 as shown in FIG. 7. When the CD 2 is positioned at a predetermined position, the interlocking mechanism makes the clamp arm 21 approach the turntable 20 and makes the roller 18 leave the disk guide 16 of the conveying unit 5.

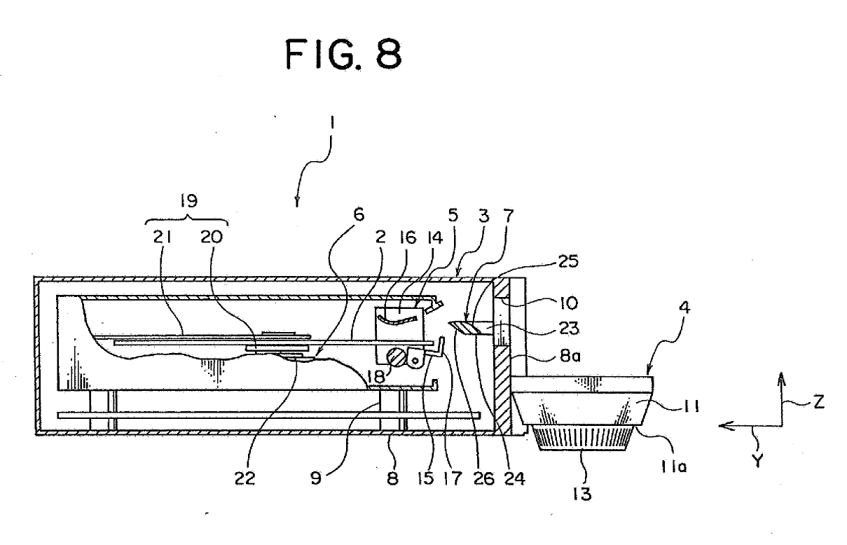

Then, as shown in FIG. 8, the clamping part 19 of the playback unit 6 clamps the CD 2 and the pickup part reads out the information from the CD 2. When the pickup part start to read out the information from the CD 2, the drive mechanism rotates the operation unit 4 around the lower end thereof so as to position the operation unit 4 at the operation position. During the playback of the CD 2, various operation is carried out by the operation unit 4.

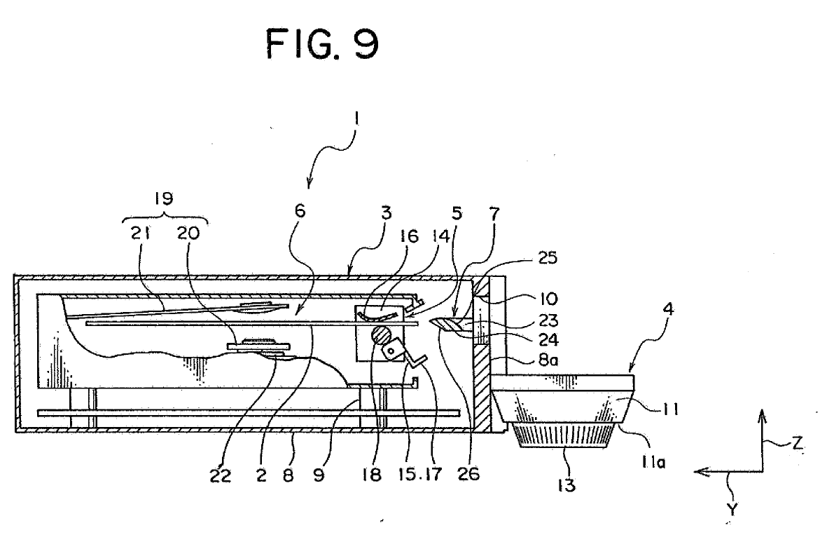

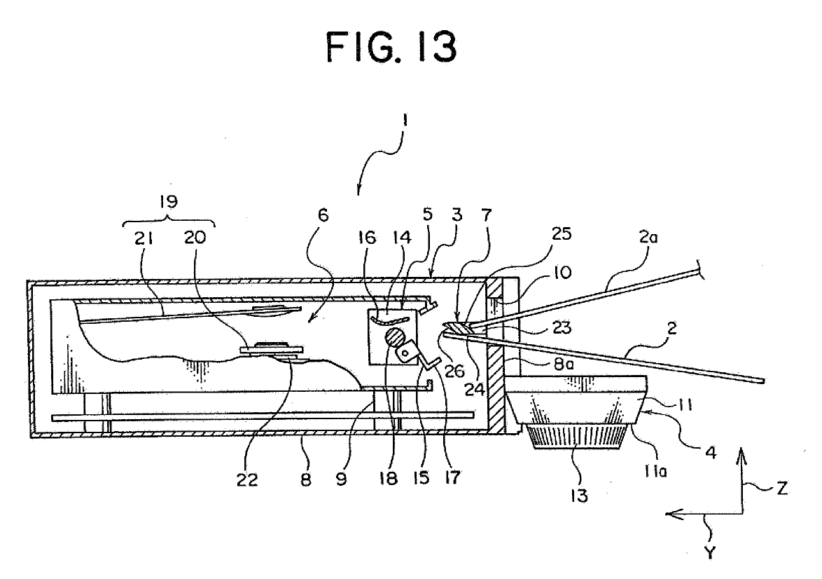

When the CD 2, from which the information is read out, is to be exchanged, that is, when the CD 2 received in the device body 3 is to be ejected from the device body 3 and a new CD 2 (shown in FIG. 13 and so on and indicated by a reference numeral 2a) is to be inserted into the device body 3, first, the switch 13 and so on for ejecting the CD 2 to the outside of the device body 3 is operated, so that the drive mechanism rotates the operation unit 4 around the lower end thereof so as to position the operation unit 4 at the insertion-ejection position. Then, as shown in FIG. 9, the interlocking mechanism makes the clamp arm 21 leave the turntable 20 and simultaneously makes the roller 18 approach the disk guide 16 of the conveying unit 5.

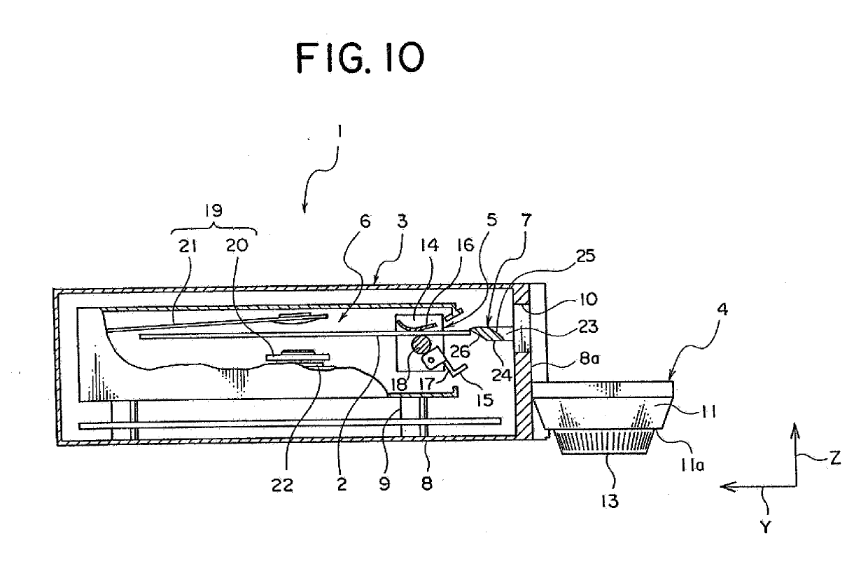

Then, the roller 18 of the conveying unit 5 rotates in a direction in which the CD 2 is ejected from the device body 3. Then, as shown in FIG. 10, the CD 2 being ejected from the device body 3 abuts against the second guide surface 26. Then, the CD 2 being ejected from the device body 3 by the second guide surface 26 is guided (i.e. positioned) to the lower side of the holding part 24 of the holding member 7 and gradually ejected to the outside of the device body 3 through the insertion opening 10.

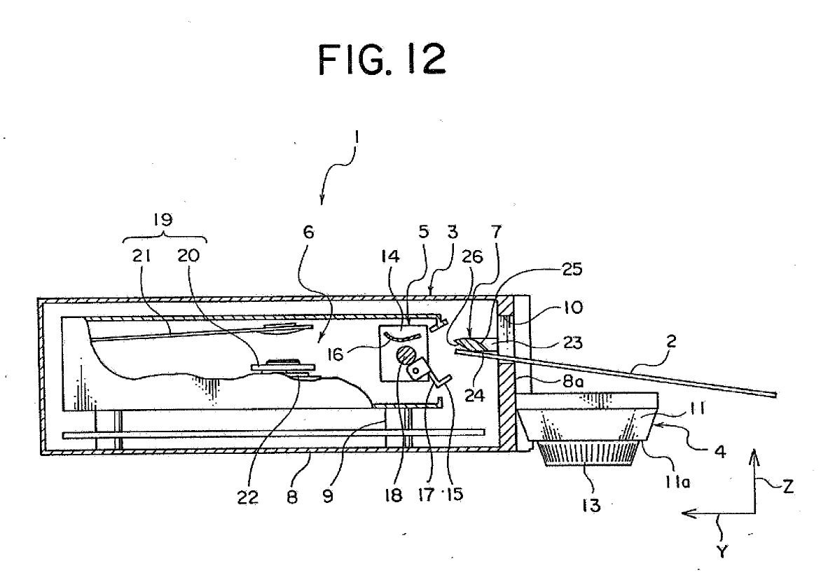

Then, the CD 2 ejected outside the device body 3 abuts against both the lower edge of the inner edge of the insertion opening 10 and the lower surface of the holding part 24 and as shown in FIG. 12, is held in the insertion opening 10 by the holding part 24 of the holding member 7 and so on. At that time, the sensor described above detects that the CD 2 is held by the holding member 7 so as to keep the operation unit 4 at the insertion-ejection position.

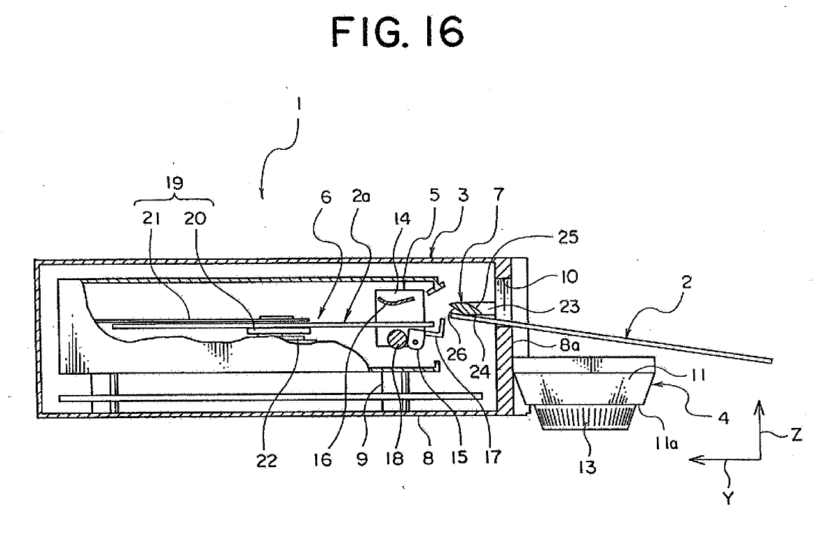

When a new CD 2a is being inserted into the device body 3 on a condition as described above, as shown in FIG. 13-15, the CD 2a is guided to the upper side of the holding part 24 of the holding member 7 by the first guide surface 25 and received into the device body 3 by the conveying unit 5 while the CD 2 being held by the holding member 7. Then, as shown in FIG. 16, the clamping part 19 of the playback unit 6 clamps the CD 2a and the pickup part reads out information of the CD 2a. In this connection, when the CD 2 held by the holding member 7 and so on in the insertion opening 10 is removed on this condition, the sensor described above detects that the holding member 7 does not hold the CD 2, so that the drive mechanism positions the operation unit 4 at the operation position.

According to the preferred embodiment described above, the holding member 7 holds the CD 2 ejected from the device body 3 in cooperation with the inner edge of the insertion opening 10 so as to permit the new CD 2a to be inserted into the device body 3. Therefore, the new CD 2a is permitted to be inserted while the CD 2 being ejected from the device body 3 is temporarily held at the device body 3. Therefore, the CD player 1 decreases a frequency of exchanging the CDs, so that time and labor required for a passenger to exchange CDs can be reduced.

The first guide surface 25 guides the new CD 2a being inserted into the device body 3 to the upper side of the holding part 24 of the holding member 7, while the second guide surface 26 guides the CD 2 being ejected from the device body 3 to the lower side of the holding part 24 of the holding member 7. Thus, a conveying route can be divided into a conveying path of the CD 2a being inserted into the device body 3 and a conveying path of the CD 2 being ejected from the device body 3. Therefore, the new CD 2a can be securely inserted into the device body 3 on a condition that the ejected CD 2 is temporarily held at the device body 3.

Since the first guide surface 25 is gradually inclined toward the upper side as the first guide surface 25 approaches the depth of the device body 3, therefore the CD 2a being inserted into the device body 3 can be securely positioned at the upper side of the holding part 24 of the holding member 7.

Since the second guide surface 26 is gradually inclined toward the lower side as the second guide surface 26 approaches the outside of the device body 3, therefore the CD 2 being ejected from the device body 3 can be securely positioned at the lower side of the holding part 24 of the holding member 7.

In the EXAMPLES described above, the CD player 1, which receives the CD 2 as the recording medium, is shown. However, instead, the present invention can be applied to other recording medium playback devices, for example, a Mini Disk player (MD player) which receives a MD as the recording medium or a Digital Versatile Disk player (DVD player) which receives a DVD as the recording medium.

In the EXAMPLES described above, the CD 2a being inserted into the device body 3 is guided to the upper side of the holding part 24 of the holding member 7, while the CD 2 being ejected from the device body 3 is guided to the lower side of the holding part 24 of the holding member 7. However, instead, the CD 2a being inserted into the device body 3 may be guided to the lower side of the holding part 24 of the holding member 7, while the CD 2 being ejected from the device body 3 may be guided to the upper side of the holding part 24 of the holding member 7.

According to the EXAMPLES described above, the following CD player 1 can be obtained.

### [Additional Remark 1]

A CD player 1 including:

a device body 3 having an insertion opening 10 through which a CD 2 passes;

a conveying unit 5 which takes the CD 2 into and out from the device body 3;

a playback unit 6 which reads out information recorded in the CD 2 inserted in the device body 3; and

a holding member 7 provided between the insertion opening 10 and the conveying unit 5,

wherein the holding member 7, together with an inner edge of the insertion opening 10, abuts against the CD 2 taken out from the device body 3 by the conveying unit 5 and permits another CD 2a to be conveyed to the playback unit 6 by the conveying unit 5 on a condition that the holding member 7 holds the CD 2 in cooperation with the inner edge of the insertion opening 10.

### [Additional Remark 2]

The CD player 1 according to the Additional Remark 1 further including:

a first guide surface 25 provided on the holding member 7; and

a second guide surface 26 provided on the holding member 7,

wherein the first guide surface 25 is provided at a position where the first guide surface 25 is capable of abutting against the CD 2 being inserted into the device body 3 through the insertion opening 10 and abuts against the CD 2 being inserted so as to guide the CD 2 to one side of the holding member 7,
wherein the second guide surface 26 is provided at a position where the second guide surface 26 is capable of abutting against the CD 2 being taken out from the playback unit 6 to the outside of the device body 3 by the conveying unit 5 and abuts against the CD 2 being taken out so as to guide the CD 2 to another side of the holding member 7.

### [Additional Remark 3]

The CD player 1 according to the Additional Remark 2, wherein the first guide surface 25 is gradually inclined toward said one side of the holding member 7 as the first guide surface 25 approaches the playback unit 6 from the insertion opening 10.

### [Additional Remark 4]

The CD player 1 according to the Additional Remark 2, wherein the second guide surface 26 is gradually inclined toward said another side of the holding member 7 as the second guide surface 26 approaches the insertion opening 10 from the playback unit 6.

According to the Additional Remark 1, the holding member 7 holds the CD 2 ejected from the device body 3 in cooperation with the inner edge of the insertion opening 10 and permits a new CD 2 to be inserted into the device body 3. That is, the CD player 1 enables that the new CD 2 is permitted to be inserted into the device body 3 on a condition that the CD 2 being ejected from the device body 3 is temporarily held. As a result, the CD player 1 decreases a frequency of exchanging the CDs, so that time and labor required for a passenger to exchange CDs can be reduced.

The aforementioned preferred embodiments are described to aid in understanding the present invention and variations may be made by one skilled in the art without departing from the spirit and scope of the present invention.

1. A recording medium playback device comprising:
a device body having an insertion opening through which a recording medium passes;
a conveying unit which takes the recording medium into and out from the device body;
a playback unit which reads out information recorded in the recording medium inserted in the device body; and
a holding member provided between the insertion opening and the conveying unit,
wherein the holding member, together with an inner edge of the insertion opening, abuts against the recording medium taken out from the device body by the conveying unit and permits another recording medium to be conveyed to the playback unit by the conveying unit on a condition that the holding member holds the recording medium in cooperation with the inner edge of the insertion opening.

2. The recording medium playback device according to claim 1 further comprising:
a first guide surface provided on the holding member; and
a second guide surface provided on the holding member,
wherein the first guide surface is provided at a position where the first guide surface is capable of abutting against the recording medium being inserted into the device body through the insertion opening and abuts against the recording medium being inserted so as to guide the recording medium to one side of the holding member,
wherein the second guide surface is provided at a position where the second guide surface is capable of abutting against the recording medium being taken out from the playback unit to the outside of the device body by the conveying unit and abuts against the recording medium being taken out so as to guide the recording medium to another side of the holding member.

3. The recording medium playback device according to claim 2, wherein the first guide surface is gradually inclined toward said one side of the holding member as the first guide surface approaches the playback unit from the insertion opening.

4. The recording medium playback device according to claim 2, wherein the second guide surface is gradually inclined toward said another side of the holding member as the second guide surface approaches the insertion opening from the playback unit.
